(19) United States
(12) Patent Application Publication
(10) Pub. No.: US 2013/0346655 A1
(43) Pub. Date: Dec. 26, 2013

(54) BUS AGENT CAPABLE OF SUPPORTING EXTENDED ATOMIC OPERATIONS AND METHOD THEREFOR

(71) Applicant: Advanced Micro Devices, Inc., Sunnyvale, CA (US)

(72) Inventor: Stephen D. Glaser, San Francisco, CA (US)

(73) Assignee: Advanced Micro Devices, Inc., Sunnyvale, CA (US)

(21) Appl. No.: 13/893,792

(22) Filed: May 14, 2013

Related U.S. Application Data
(60) Provisional application No. 61/663,363, filed on Jun. 22, 2012.

(51) Int. Cl. G06F 13/38

(52) U.S. Cl. CPC G06F 13/385
USPC 710/105

(57) ABSTRACT

A bus protocol compatible requester includes a bus protocol port for transmitting bus protocol compatible requests to a bus protocol link, and an extended atomic operation generation system, coupled to the bus protocol port, for generating an extended atomic operation by using at least one bit in a field of a standard bus protocol request other than an opcode field, and providing the extended atomic operation to the bus protocol port for transmission to a completer. A bus protocol compatible completer includes a bus protocol port for receiving bus protocol compatible requests from a bus protocol link, and an extended atomic operation execution system, coupled to the bus protocol port, for decoding an extended atomic operation according to at least one bit in a field of a standard bus protocol request other than an opcode field, and executing the extended atomic operation according to the at least one bit.

This application is a non-provisional application of and claims priority to U.S. Provisional Patent Application No. 61/663,363 filed on Jun. 22, 2012 and entitled “Bus Agent Capable of Supporting Extended Atomic Operations and Method Therefor,” which is incorporated herein by reference in its entirety.

### FIELD

This disclosure relates generally to computer bus agents, and more specifically to bus agents capable of generating or executing atomic operations.

### BACKGROUND

Several existing bus protocols define atomic operations. For example, the PCI Express (PCIe) standard is an extension of the PCI standard that uses existing PCI programming concepts. Currently, state-of the-art PCIe compatible systems support a limited number of base atomic operations. The current PCIe specification, PCIe Base Specification Revision 3.0, published by the PCI Special Interest Group, describes atomic operations as single PCIe transactions that target a memory location, read a value from the memory location, and generally write a new or modified value back to the memory location. In some cases, the original value is also written back to the memory location.

The OpenCL (Open Computing Language) specification, specified by the Khronos OpenCL Working Group, is a standard that generally provides processing units with a framework, language, application programming interface (API), and system that supports parallel software development. Currently, OpenCL compatible standards support base atomic operations and some extended atomic operations. OpenCL atomic operations include support for 32 bit and 64 bit, local memory and global memory, and signed and unsigned operands. However, there is limited support for current and future extended atomic operations in PCIe compatible standards.

The PCIe standard describes use models and benefits for atomic operations. In general, atomic operations operate concurrently without significant disruption to other PCIe operations, while providing lower latency and higher scalability as compared to legacy locked transactions. However, as computer technology in general, and PCIe compatible architectures in particular continue to advance, it would be desirable to support extended atomic operations, including OpenCL atomic operations. However, PCIe only has a small number of extra opcodes available, far less than the number of OpenCL atomic operations.

Also, PCIe does not permit read, write, or atomic operations to cross a 4 kilobyte (kB) page boundary. This limitation restricts the range of supported atomic operations and the ability to implement the full range of OpenCL compatible atomic operations.

### BRIEF DESCRIPTION OF THE DRAWINGS

FIG. 1 illustrates in block diagram form a PCIe compatible computer system that supports extended atomic operations.

FIG. 2 illustrates in block diagram form a PCIe system including PCIe compatible bus agents known in the prior art.

FIG. 3 illustrates in block diagram form a PCIe system including PCIe compatible bus agents that support extended atomic operations according to some embodiments.

FIG. 4 illustrates an encoding of a PCIe compatible generic transaction layer packet (TLP).

FIG. 5 illustrates a flow chart of a method for encoding and decoding extended PCIe atomic operations using the TLP packet of FIG. 4, according to some embodiments.

FIG. 6 illustrates a first encoding of a TLP header for an extended PCIe atomic operation, according to some embodiments.

FIG. 7 illustrates a second encoding of a TLP header for an extended PCIe atomic operation, according to some embodiments.

FIG. 8 illustrates an encoding of a TLP TPH prefix for an extended PCIe atomic operation, according to some embodiments.

FIG. 9 illustrates an encoding of a new TLP prefix for an extended PCIe atomic operation, according to some embodiments.

FIG. 10 illustrates a flow chart of a method for processing an extended PCIe posted atomic operation that may fall near a 4 kB boundary, according to some embodiments.

In the following description, the use of the same reference numerals in different drawings indicates similar or identical items.

### DETAILED DESCRIPTION OF ILLUSTRATIVE EMBODIMENTS

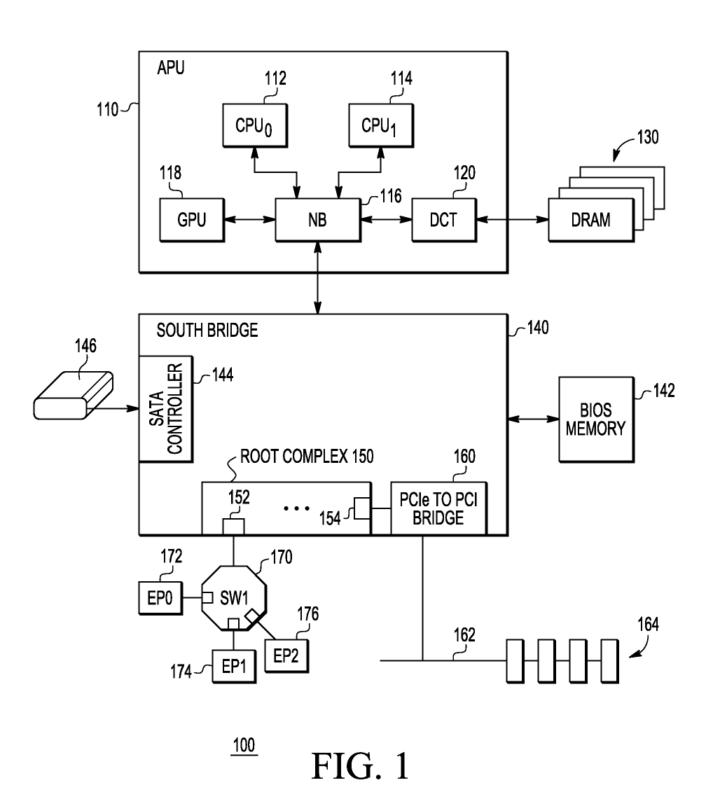

FIG. 1 illustrates in block diagram form a PCIe compatible computer system 100 that supports extended atomic operations. System 100 generally includes an accelerated processing unit (APU) 110, a memory system 130, a system controller chip known as a “Southbridge” (SB) 140, a system BIOS (Basic Input Output System) memory 142, a SATA (Serial Advanced Technology Attachment) mass storage system 146, a set of PCI compatible peripherals 164, a PCIe switch 170 labeled “SW1”, and PCIe endpoints (EP) 172, 174, and 176 respectively labeled “EP0”, “EP1”, and “EP2”. As those of ordinary skill in the art would understand, there are many varieties of PCIe (e.g., PCIe 3.0, PCIe 2.0, etc.) along with other bus protocols similar to PCIe such as HyperTransport™, Infiniband, and others. Aspects of the bus agents that support extended atomic operations disclosed herein could be applied to bus protocols other than PCIe.

APU 110 generally includes central processing unit (CPU) cores 112 and 114 labeled “CPU₀” and “CPU₁”, a system controller known as a “Northbridge” (NB) 116, a graphics processing unit (GPU) 118, and a DRAM controller (DCT) 120. CPU core 112 has a bidirectional port connected to a bidirectional port of NB 116 over a bidirectional bus. CPU core 114 has a bidirectional port connected to a bidirectional port of NB 116 over a bidirectional bus. NB 116 has three additional bidirectional ports, including a first bidirectional port connected to a bidirectional port of GPU 118 over a bidirectional bus, a second bidirectional port connected to a bidirectional port of DRAM controller 120 over a bidirectional bus, and a third bidirectional port connected to a bidirectional port of SB 140 over a bidirectional bus. DRAM controller 120 has a bidirectional port connected to memory system 130 over a bidirectional DRAM memory system bus.

SB 140 generally includes a SATA controller 144, a root complex 150, and a PCIe to PCI bridge 160. SB 140 has a bidirectional port connected to a bidirectional port of system BIOS 142 over a bidirectional bus. SATA controller 144 has a bidirectional port connected to a bidirectional port of SATA mass storage system 146 over a bidirectional bus. Root complex 150 has a root port 152 connected to a PCIe switch 170 over a dual uni-directional PCIe link. PCIe switch 170 is connected to EP0 172, EP1 174, and EP2 176, over three dual uni-directional PCIe links, respectively. Root complex 150 also has a root port 154 connected to a bidirectional port of PCIe to PCI bridge 160 over a bidirectional bus. PCIe to PCI bridge 160 has a bidirectional port connected to a legacy PCI bus 162. Legacy PCI bus 162 connects to set of PCI compatible peripherals 164.

In operation, SB 140 interfaces system 100 to various low-speed peripherals in a conventional manner, and to provide operation compatible with the existing PCIe standard. SB 140 is further adapted to support both base atomic operations and extended atomic operations, and operates as an extended atomic operation generation system. Root complex 150 transmits PCI requests to a PCIe compatible link. As is known, the PCIe standard provides capability for a PCIe compatible link to include N optional lanes (“by-N”). For example, a by-8 link is classified as having eight physical lanes. According to the PCIe standard, an EP receives and provides TLPs. TLPs are transferred between various PCIe compatible requesters and completers of the PCIe compatible system 100.

For some transactions, such as programmed I/O transactions, root complex 150 operates as a PCIe compatible requester to send request TLPs to EP0 172. In response to PCIe requests, EP0 172 functions as a PCIe compatible completer to provide the response packets known as completions. In general, as defined by the PCIe standard, EP0 172 must support configuration requests as a completer and must not generate I/O requests. Response packets include simple completions and completions with data. Alternately for some transactions, such as memory transactions, EP0 172 has the capability to function as a PCIe compatible requester, and root complex 150 has the capability to function as a PCIe compatible completer. In yet another example, for some transactions, such as peer-to-peer transactions, EP0 172 has the capability to function as a PCIe compatible requester and EP1 174 has the capability to function as a PCIe compatible completer. Also, the PCIe standard allows root complex 150 itself to have integrated endpoints. In general, an endpoint integrated in root complex 150 supports configuration requests as a completer and does not have the capability to generate I/O requests.

According to the PCIe standard, atomic operations are single PCIe transactions that target a memory location, read a value from the memory location, and generally write a new or modified data back to the memory location. In some cases, the original value is also written back to the memory location. Currently, the PCIe standard supports three base atomic operations, known as FetchAdd, Swap, and Compare and Swap (CAS). The PCIe standard defines these base atomic operations as non-posted memory transactions that support 32-bit and 64-bit address formats. As is known, a PCIe compatible requester initiates a non-posted memory transaction by transmitting a TLP packet to a PCIe compatible completer. Subsequently, the PCIe compatible completer returns a completion data packet along with additional data using a split transaction protocol. Such a non-posted memory transaction is used to complete the handshake process to provide a confirmation of the transaction. However, non-posted atomic operations tie up the link and prevent other operations from taking place until the requester receives the completion packet. The length of time these atomic operations tie up the link increases as the link topology becomes more complex, such as when the system runs PCIe over a non-PCIe protocol such as IEEE 802.11.

As explained below, however, system 100 not only supports PCIe base atomic operations, but also supports extended atomic operations, which include posted atomic operations. This new capability can be standardized in a future version of a PCIe compatible standard, or until the new revision is completed, in an interim engineering change notice (ECN). Also, it would be desirable to extend support for OpenCL atomic operations to include increasing support for 32-bit and 64-bit, local memory and global memory, and signed and unsigned operands. In general, the new solution provides for extended support of OpenCL atomic operations and provides for a mechanism to extend this support to future PCIe standards.

FIG. 2 illustrates in block diagram form a PCIe system 200 including PCIe compatible bus agents known in the prior art. System 200 generally includes a requester 210, a completer 220, and a PCIe link 230. PCIe link 230 is a dual unidirectional link, and PCIe compatible requester 210 has an egress port connected to an ingress port of PCIe compatible completer 220, and an ingress port connected to an egress port of PCIe compatible completer 220, over PCIe link 230.

In operation, PCIe compatible requester 210 and PCIe compatible completer 220 exchange PCIe packets and correspond to different elements in a computer system. PCIe link 230 forms a dual simplex communication path between PCIe compatible requester 210 and PCIe compatible completer 220. Supported transactions include a base atomic operation 240 as shown in FIG. 2. PCIe requestor 210 transmits base atomic operation 240 on its outgoing (egress) port, and PCIe completer 220 receives base atomic operation 240 on its incoming (ingress) port. After completing the atomic operation, completer 220 transmits a completion packet 250, either a completion without data (Cpl) or completion with data (CplD), back to requestor 210.

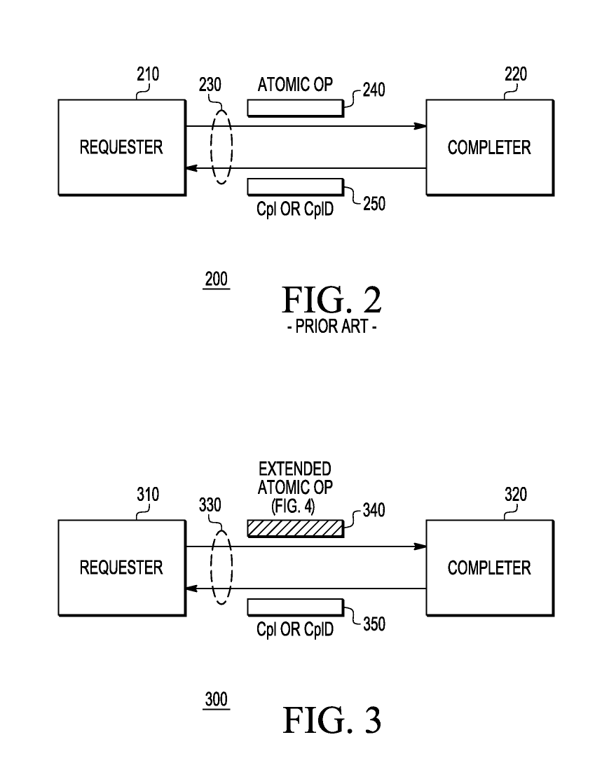

FIG. 3 illustrates in block diagram form a PCIe system 300 with PCIe compatible bus agents that support extended atomic operations according to some embodiments. System 300 generally includes a PCIe compatible requester 310, a PCIe compatible completer 320, and a PCIe link 330. PCIe compatible requester 310 has an egress port connected to an ingress port of PCIe compatible completer 320, and an ingress port connected to an egress port of PCIe compatible completer 320, over PCIe link 330.

In operation, PCIe compatible requester 310 and PCIe compatible completer 320 exchange PCIe packets and correspond to different elements in computer system 100. However unlike the bus agents in PCIe system 200, requestor 310 is capable of sending an extended atomic operation 340, and completer 320 is capable of decoding and executing extended atomic operation 340 and returning a completion 350, either a completion without data (Cpl) or a completion with data (CplD), in response. If extended atomic operation 340 is a posted atomic operation, then completer 320 is capable of returning completion 350 before it completes the operation, allowing for the transmission of other PCIe transactions on PCIe link 330.

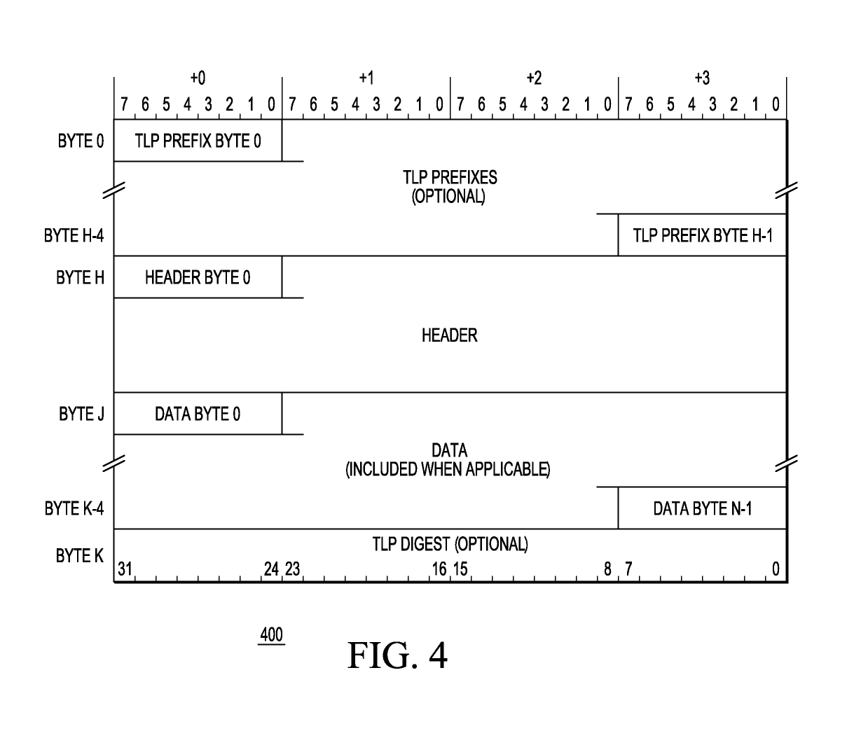

FIG. 4 illustrates an encoding of a PCIe compatible generic transaction layer packet (TLP) 400. TLP 400 includes various fields shown in TABLE I below:

TABLE I

| Packet Field | Function |
|---|---|
| TLP PREFIXES | Additional optional information that may be prepended to TLP 400 |
| HEADER | A set of fields at or near the front of TLP 400, having information required |
| | to determine the characteristics and purpose of TLP 400 |
| DATA | Information, when applicable, following the header in TLP 400 packets to |
| | be used by a target function receiving TLP 400 |
| TLP DIGEST | Additional, optional information included in TLP 400 packets, for |
| | example, a cyclic redundancy check (“CRC”) code |

TLP 400 is defined in the PCIe standard and includes optional TLP prefixes, a header, data, and an optional TLP digest. The TLP header includes the format of the packet, type of the packet, length of the packet, byte enables, message encoding, and completion status. A particular bit of the header known as the TH bit indicates if TLP processing hints (TPH) are included in the TLP header. TPH are optional bits of the TLP header that provide hints in a request TLP to provide optimization of resources for the system hardware.

In operation, after configuration, system 100 routes packets as defined in the PCIe standard for TLP routing, I/O-based TLP routing, and message routing. The PCIe compatible requester initiates a request, such as a memory read request, by forming a TLP. Reserved fields are ignored by endpoints and the values of the reserved fields will not be modified when the TLP passes through switches such as switch 170. As a result, in order to provide extended atomic operation 340, requestor 310 uses other bit fields as a mechanism to define the extended atomic operations. However instead of using the limited reserved opcodes or reserved bits, in some embodiments, requestor 310 uses bit fields that have a defined purpose for certain operations, but are optional or unused for other operations. Requestor 310 uses these selected fields to encode the particular extended atomic operations.

By way of example, referring back to FIG. 1, root complex 150 operates as a PCIe compatible requestor 310 when it generates an extended atomic operation 340. In some embodiments, it identifies the extended atomic operation by using at least one bit in a field of the TLP memory request prefix, header, data, and digest fields, other than the Type field that PCIe uses to indicate opcodes. PCIe compatible completer 320 in turn decodes and executes the extended atomic operation 340 according to the at least one bit, and subsequently returns a completion packet to root complex 150. By not changing the Type field from legacy atomic operations to indicate the new extended atomic operations, system 300 avoids the need to redesign switches. Various techniques for encoding an extended atomic operation in fields other than the Type field will now be described.

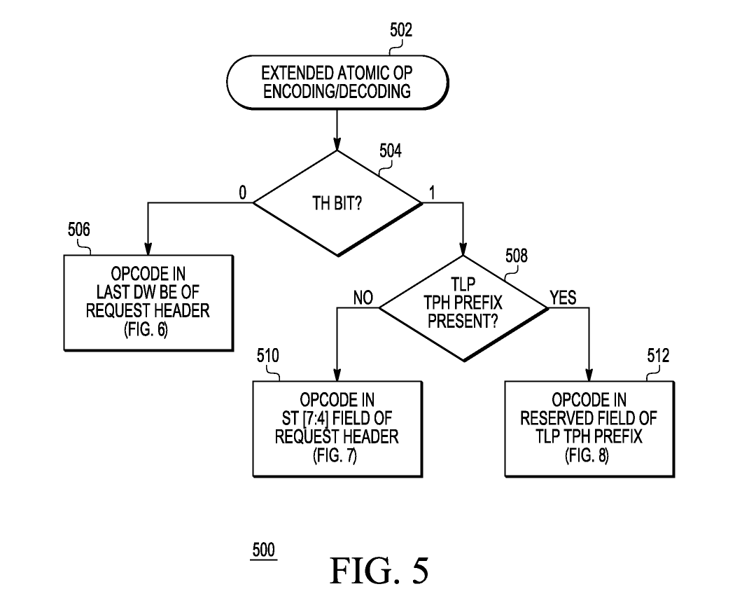

FIG. 5 illustrates a flow chart of a method 500 for encoding and decoding extended PCIe atomic operations using TLP packet 400 of FIG. 4, according to some embodiments. A PCIe compatible requestor uses method 500 to encode an extended atomic operation. At action box 502, the PCIe requester receives an extended atomic operation for encoding. At decision box 504, the PCIe requester determines the state of the TH bit in the PCIe TLP. If the TH bit is clear (binary 0), then at action box 506 the PCIe requestor encodes an opcode for the extended PCI atomic operation in a LAST DW BE field in the PCIe TLP. If however the TH bit is set (binary 1), then method 500 proceeds to decision box 508, which determines whether a TLP transaction processing hints (TPH) prefix is present. If a TLP TPH prefix is not present, then at action box 510 the PCIe requester encodes an opcode for the extended PCIe atomic operation in a steering tag (ST) field, for example, field ST[7:4], in the PCIe TLP header. If a TLP TPH prefix is present, then at action box 512 the PCIe requester encodes the opcode in a reserved field of the TLP TPH prefix. These modified encodings of existing TLPs will be explained further below.

According to the PCIe specification, an atomic operation supports transaction flows including device-to-host, device-to-device, and host-to-device transactions. As defined, PCIe compatible completer 220 and all intermediate routing elements must support associated legacy atomic operation capabilities. Also, completer 220 has the capability to determine if legacy atomic operations are enabled. However, in system 300, PCIe compatible completer 320 supports extended atomic operations. In order for a requester in a PCIe system to generate atomic operations, the root complex first determines whether all devices and switches support atomic operations. Likewise, in order for a requester 310 in PCIe system 300 to generate extended atomic operations, the root complex first determines whether all devices and switches, such as completer 320, support extended atomic operations. In one embodiment, completers in system 300 may indicate support for extended atomic operations by using an additional capability bit in their respective configuration spaces. In an alternative embodiment, the root complex may determine whether completers in system 300 support extended atomic operations experimentally. In this case, the root complex can generate a trial extended atomic operation and observe whether the completer returns an appropriate result or unsupported request (“UR”). This alternative embodiment requires some overhead during configuration but determines support for extended atomic operations without the necessity of a new engineering change notice (“ECN”) to define a new capability bit.

Software generally defines ST values for requester 310, including ST [7:4]. For legacy atomic operations, ST [7:4] is defined as zero (“0000”). In the PCIe specification, the ST bits are “opaque” data values. As such, software has no visibility with respect to the internal operation of these bits. In general, completer 320 has the capability to control its response to additional non-zero values that the programming model defines for the ST [7:4] field. However in system 300, requester 310 encodes an extended atomic operation 340 when the Type field indicates a legacy atomic operation and the ST [7:4] field is non-zero. Completer 320 decodes and executes an extended atomic operation 340 when the Type field indicates a legacy atomic operation and the ST [7:4] field is non-zero.

As a first example, when the Type field indicates a FetchAdd, a zero ST [7:4] field defines a PCIe legacy FetchAdd atomic operation. However, when the Type field indicates a FetchAdd, a non-zero ST [7:4] field defines a PCIe extended atomic operation, such as extended Atom_float_min. Thus, the extended atom_float_min opcode is mapped onto the legacy atomic operation FetchAdd opcode. The width of the operation can be defined as 32 bit or 64 bit, with optional support for denormalized numbers with single precision floating-point.

As a second example, read transactions and legacy atomic operations are defined as non-posted transactions, and non-posted transactions return a completion response. However, a PCIe extended posted atomic operation would not return a completion response although it is mapped into a legacy (non-posted) atomic operation. Using the encoding as described above, completer 320 has the capability to distinguish legacy non-posted write transactions from extended posted atomic operations. Completer 320 can make such a determination by interpreting certain defined non-zero ST [7:4] values as posted PCIe extended atomic operations.

A PCIe compatible completer uses method 500 to decode an extended atomic operation. At action box 502, the PCIe completer receives an extended atomic operation for decoding. At decision box 504, the PCIe completer determines the state of the TH bit of the TLP header. If the TH bit is clear (binary 0), then the PCIe completer decodes the opcode from the LAST DW BE field of the request header in action box 506. If the TH bit is set (binary 1), then the PCI completer further determines whether the TPH prefix is present at decision box 508. If the TPH prefix is not present, then the PCIe completer decodes the opcode from the ST[7:4] field of the request header in action box 510. If the TPH prefix is present, then the PCIe completer decodes the opcode of the TLP TPH prefix in action box 512.

The PCIe completer then executes the operation so decoded, returning a Cpl or CplD packet as appropriate. If the atomic operation is posted, then the PCIe completer returns a Cpl or CplD packet before completion.

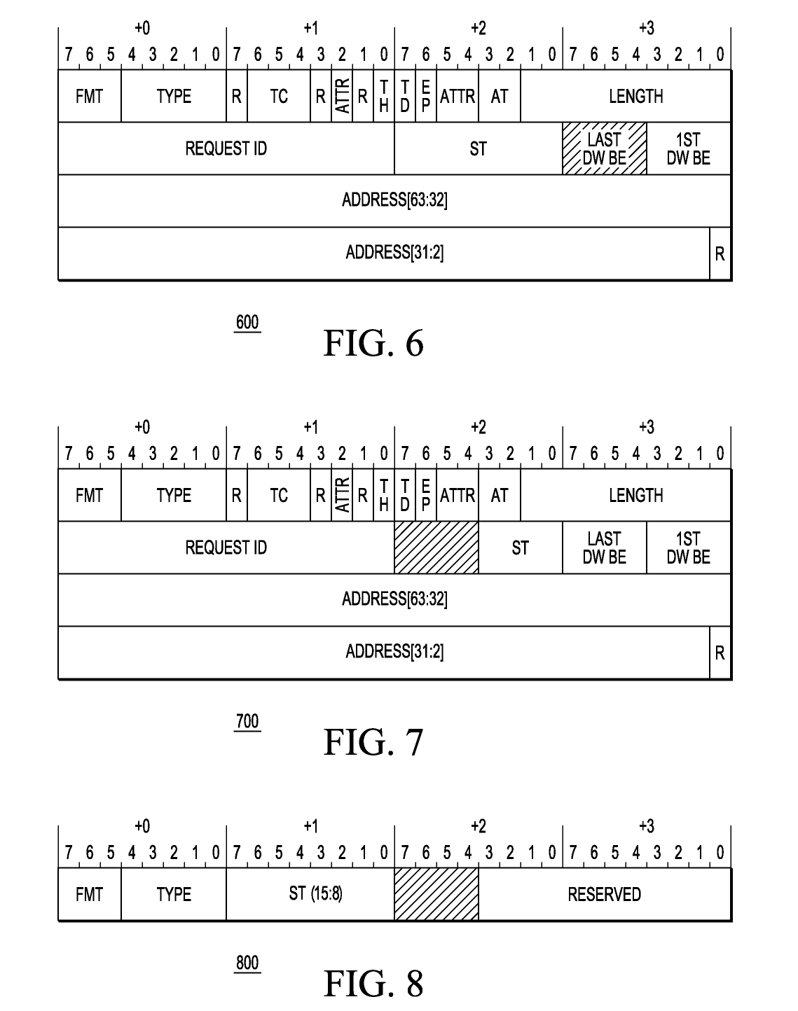

FIG. 6 illustrates a first encoding of a TLP header 600 for a PCIe extended atomic operation, according to some embodiments. As shown in FIG. 6, TLP header 600 includes four double words with various fields shown in TABLE II below:

TABLE II

| Packet Field | Function |
|---|---|
| FMT | Format of the TLP |
| Type | Transaction type (memory, I/O, configuration, message) of the TLP |
| R | Reserved field, must be filled with 0 (s) when the TLP is formed |
| TC | Traffic class used to apply appropriate servicing policies for quality of |
| | service (“QOS”) |
| ATTR | Attributes, specifying the characteristics of the transaction |
| TH | Field indicating the presence of TLP TPH in the TLP header and optional |
| | TPH TLP prefix fields |
| TD | Field indicating the presence of the TLP digest in the form of a single double |
| | word (“DW”) at the end of the TLP |
| EP | Field indicating that the TLP is poisoned (an error, such as an unexpected |
| | completion) |
| AT | Address type (default/untranslated, translation request, translated, reserved) |
| LENGTH | Length of the data payload of the TLP |
| REQUESTER ID | 16-bit value that is unique for every PCIe function within a hierarchy. |
| ST [7:0] | Steering Tag field defining system specific values that provide information |
| | about the host or cache structure in the system cache hierarchy |
| Last DW BE | Field containing byte enables for the last double word of a request TLP |
| 1st DW BE | Field containing byte enables for the first double word of a request TLP |
| Address [63:32] | Long address format for a 32-bit address based TLP transaction |
| Address [31:2] | Short address format for a 64-bit address based TLP transaction |

TLP header 600 indicates the extended atomic operation in the last double word byte enable (Last DW BE) field in the TLP header. If a Last DW BE field is present, it is included in the TLP 400 header. According to the PCIe standard, the Last DW BE field is used only if the data length is greater than one double word. For atomic operations having the TH bit set, the Last DW Byte Enable field serves a different purpose, to include the ST [7:0] field. In general, for atomic operations, the DW BE field value is not used. The LAST DW BE field has a defined purpose for certain operations, but is unused when the TH bit is 0, and TLP header 600 uses it to encode the extended atomic operation.

FIG. 7 illustrates a second encoding of a TLP header for a PCIe extended atomic operation in a TLP header 700, according to some embodiments. TLP header 700 includes four double words with various fields shown in TABLE II above. TLP header 700 indicates the extended atomic operation in bits [7:4] of the steering tag (ST) field. If an ST field is present, it is included in the TLP 400 header. According to the PCIe standard, for some usage models the ST field is not required or not provided, and in such cases a function is permitted to use a value of all zeroes in the ST field to indicate no ST preference. In general for atomic operations, the ST field value is not used. Thus, the selected ST bit fields have a defined purpose for certain operations, but are optional or unused for other operations, such as atomic operations. These selected fields are redefined to indicate particular extended atomic operations.

FIG. 8 illustrates an encoding of a TLP TPH prefix 800 for an extended PCIe atomic operation, according to some embodiments. As shown in FIG. 8, TLP TPH prefix 800 includes four double words with various fields shown in TABLE III below:

TABLE III

| Packet Field | Function |
|---|---|
| Fmt | Format of TLP 800 |
| Type | Transaction type (memory, I/O, configuration, message) |
| | of TLP 800 |
| ST [7:0] | Steering Tag field defining system specific values that provide |
| | information about the host or cache structure in the system |
| | cache hierarchy |
| Reserved | The contents, states, or information are not defined. Using any |
| | reserved area of a TLP 800 packet is not permitted |

TLP TPH prefix 800 indicates the PCIe extended atomic operation in a reserved field of the TLP Processing Hints (TLP TPH) prefix. TPH is an optional component of the TLP 400 that provides hints in the request TLP 400 header intended to provide optimization of resources for the system hardware. An optional TLP TPH prefix 800 extends the TLP 400 fields to provide additional bits for the Steering Tag (ST) field. The selected TLP TPH prefix bits have a defined purpose for certain operations, but are optional or unused for other operations, such as atomic operations. These selected fields are redefined to indicate the particular extended atomic operations.

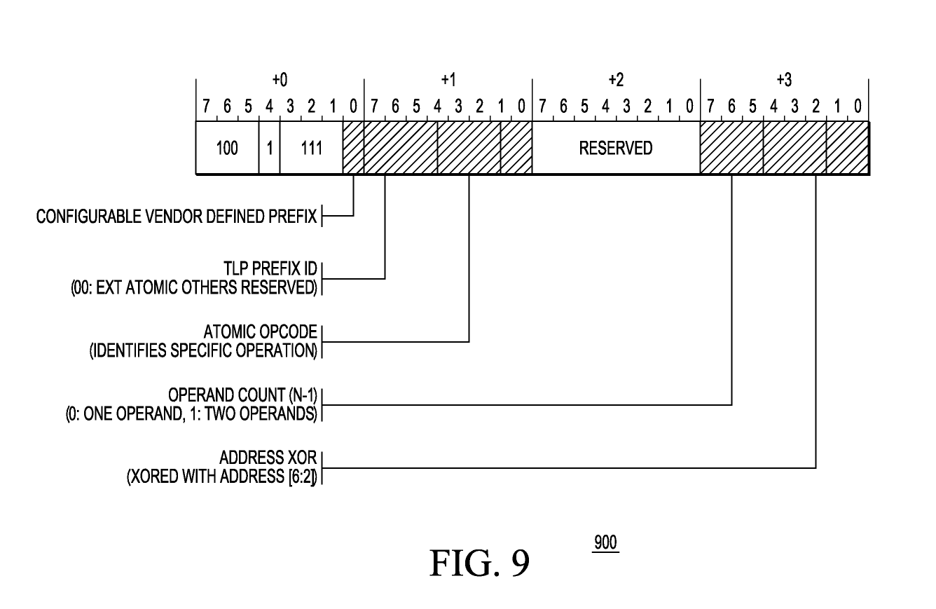

FIG. 9 illustrates an encoding of a new TLP prefix 900 for an extended PCIe atomic operation, according to some embodiments. As shown in FIG. 9, TLP prefix 900 includes various fields shown in TABLE IV below:

TABLE IV

| Packet Field | Function |
|---|---|
| Configurable Vendor | Encoded field so that components may be configurable |
| Defined Prefix | |
| Prefix ID | Two vendor defined local TLP 900 prefix encodings. |
| | For example each end of a link could transmit the |
| | same prefix using a different encoding |
| Atomic Opcode | Identifies a specific atomic operation of TLP 900 |
| Reserved | The contents, states, or information are not defined. |
| | Using any reserved area of a TLP 900 packet is |
| | not permitted |
| Operand Count | N-1, 0: one operand, 1, two operands, . . . |
| Address XOR | XORed with address bits [6:2] |

As an alternate new solution for implementing PCIe extended atomic operations, PCIe compatible requester 310 transmits extended atomic operations by sending a TLP with a TLP prefix 900. TLP prefix 900 is new prefix dedicated to extended atomic operations. TLP prefix 900 is fully PCIe compliant, and also offers a wide range of bits for use. Also, TLP prefix 900 can be supported by existing PCIe switches when an end-to-end prefix support capability bit is set.

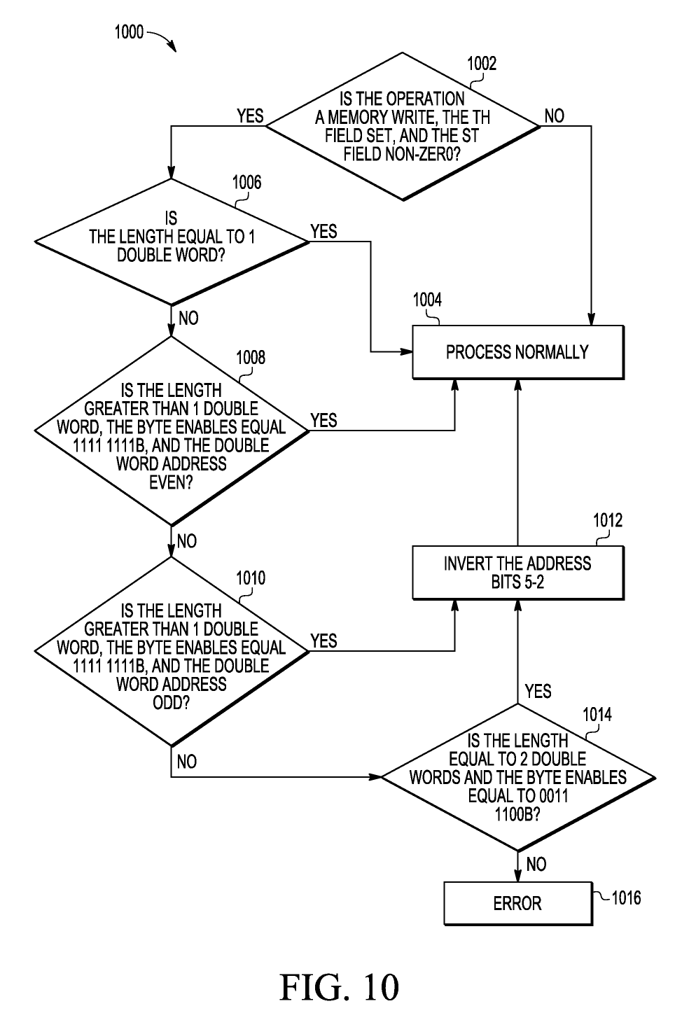

FIG. 10 illustrates a flow chart of a method 1000 for processing an extended PCIe posted atomic operation that may fall near a 4 kB boundary. At decision box 1002, the completer determines whether the operation is a memory write, the TH field is set, and the ST field is non-zero. If not, then method 1000 proceeds to box 1004, at which the completer processes the TLP base or extended atomic transaction normally. If so, then method 1000 proceeds to decision box 1006. At decision box 1006, the completer determines whether the packet length is equal to 1 double word. If so, then method 1000 proceeds to box 1004 and the completer processes the TLP base or extended atomic transaction normally. If not, i.e. if the length of the packet is greater than 1 double word, then method 1000 proceeds to decision box 1008. At decision box 1008, the completer determines whether the length is greater than one double word, the byte enables are equal to 1111111b, and the double word address is even. If so, then method 1000 proceeds to box 1004, at which the completer processes the TLP base or extended atomic transaction normally. If not, then method 1000 proceeds to decision box 1010. At decision box 1010, the completer determines whether the length of the packet is greater than 1 double word, the byte enables are equal to 1111111b, and the double word address is odd. If so, then method 1000 proceeds to box 1012, at which the completer inverts address bits [5:2], and then to box 1004, at which the completer processes the modified TLP base or extended atomic transaction normally. If not, then method 1000 proceeds to decision box 1014. At decision box 1014, the completer determines whether the packet length is equal to 2 double words and the byte enables are equal 00111100b. If so, then method 1000 proceeds to box 1012, at which the completer inverts the address bits [5:2], and then to box 1004, at which the completer processes the modified TLP base or extended atomic transaction normally. If not, then method 1000 proceeds to box 1016, and the completer reports an error condition.

In operation, according to the PCIe standard, all memory, I/O, and configuration requests must follow a set of rules. For example, one rule does not allow an atomic operation request to use an address and length of packet combination that results in a memory space access that crosses a 4-KB boundary. The protocol provides a way to check this rule, however for typical operations the TLP is classified as a malformed TLP. For existing PCIe atomic operations, the PCIe standard guarantees that crossing a 4-KB boundary will not occur. Method 1000, however, provides a mechanism for relaxing this limitation by modifying a posted atomic operation that would otherwise cross a 4-KB boundary, by selectively inverting a portion of the address in response to an operand length.

Method 1000 determines whether the posted atomic operation crosses a 4K memory boundary. If the posted atomic operation crosses this boundary, a portion of an address of the posted atomic operation is inverted to provide a partially inverted address, and the posted atomic operation is processed normally using the partially inverted address. If it is determined the posted atomic operation cannot cross the predetermined memory boundary, the posted atomic operation is processed normally.

The functions of requestor 310 or completer 320 of FIG. 3 may be implemented with various combinations of hardware and software. Some of the software components may be stored in a computer readable storage medium for execution by at least one processor. Moreover the methods illustrated in FIGS. 5 and 7 may also be governed by instructions that are stored in a computer readable storage medium and that are executed by at least one processor. Each of the operations shown in FIGS. 5 and 7 may correspond to instructions stored in a non-transitory computer memory or computer readable storage medium. In various embodiments, the non-transitory computer readable storage medium includes a magnetic or optical disk storage device, solid-state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

Moreover, the circuits of FIG. 3 may be described or represented by a computer accessible data structure in the form of a database or other data structure which can be read by a program and used, directly or indirectly, to fabricate integrated circuits with the circuits of FIG. 3. For example, this data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising integrated circuits with the circuits of FIG. 3. The netlist may then be placed and routed to produce a data set describing geometric shapes to be applied to masks. The masks may then be used in various semiconductor fabrication steps to produce integrated circuits of FIG. 3. Alternatively, the database on the computer accessible storage medium may be the netlist (with or without the synthesis library) or the data set, as desired, or Graphic Data System (GDS) II data.

According to one aspect of the disclosed embodiments, a bus protocol compatible completer includes a bus protocol port for receiving bus protocol compatible requests from a bus protocol link, and a posted atomic operation execution system, coupled to the bus protocol port, for detecting a posted atomic operation to a memory location near an end of a page, and for executing the posted atomic operation by selectively inverting a portion of an address of the posted atomic operation in response to an operand length of the posted atomic operation. In some embodiments, the memory location near the end of the page is a memory location within four bytes of an end of a four kilobyte (4 kB) page boundary. Moreover according to some embodiments the posted atomic operation execution system executes the posted atomic operation by selectively inverting the portion of the address of the posted atomic operation further in response to a value of a plurality of byte enable bits. In these embodiments, the posted atomic operation execution system may execute the posted atomic operation by selectively inverting the portion of the address of the posted atomic operation further in response to a value of a least significant double word address bit. The posted atomic operation execution system may further execute the posted atomic operation by inverting the portion of the address of the posted atomic operation in response to a length field (LENGTH) being greater than one double word, the plurality of byte enables being equal to 1111 1111b, and the least significant double word address bit being 1b. The posted atomic operation execution system may also execute the posted atomic operation by inverting the portion of the address of the posted atomic operation in response to a length being equal to two double words and the plurality of byte enables being equal to 0011 1100b.

According to another aspect of the disclosed embodiments, a method for processing a posted atomic operation in a bus protocol compatible completer includes detecting a posted atomic operation, determining whether the posted atomic operation may cross a predetermined memory boundary, if the posted atomic operation may cross the predetermined memory boundary, inverting a portion of an address of the posted atomic operation to provide a partially inverted address, and processing the posted atomic operation normally using the partially inverted address, and if the posted atomic operation cannot cross the predetermined memory boundary, processing the posted atomic operation normally. In some embodiments, the detecting includes detecting a peripheral component interconnect (PCI) Express posted atomic operation. The detecting may further include detecting the PCI Express posted atomic operation if a packet type field (Type) indicates a memory write operation, a TH bit is set, and a steering tag (ST) field is nonzero. In some embodiments, the determining includes determining that the posted atomic operation may cross the predetermined memory boundary if a length field (LENGTH) is greater than one double word, associated byte enables are equal to 1111 1111b, and a double word address is even. In some embodiments, the determining includes determining that the posted atomic operation may cross the predetermined memory boundary if a length field (LENGTH) is equal to two double words, and associated byte enables are equal to 0011 1100b.

While the invention has been described in the context of a preferred embodiment, various modifications will be apparent to those skilled in the art. For example, PCIe compatible architecture 100 is exemplary, and additional peripherals can be included. The architecture of accelerated processing unit 110, NB 116, and SB 140, for example, can be implemented on multiple integrated circuits (ICs) or a single IC. Accordingly, it is intended by the appended claims to cover all modifications of the invention that fall within the true scope of the invention.

What is claimed is:

1. A bus protocol compatible requester, comprising:
a bus protocol port for transmitting bus protocol compatible requests to a bus protocol link; and
an extended atomic operation generation system, coupled to the bus protocol port, for generating an extended atomic operation by using at least one bit in a field of a standard bus protocol request other than an opcode field, and providing the extended atomic operation to the bus protocol port for transmission to a completer coupled to the bus protocol link.

2. The bus protocol compatible requester of claim 1, wherein the bus protocol is peripheral component interconnect (PCI) Express.

3. The bus protocol compatible requester of claim 2, wherein the opcode field comprises a PCI Express Type field.

4. The bus protocol compatible requester of claim 2, wherein the extended atomic operation generation system comprises a PCI Express root complex.

5. The bus protocol compatible requester of claim 2, wherein the extended atomic operation generation system comprises a PCI Express endpoint.

6. The bus protocol compatible requester of claim 2, wherein the bus protocol requests comprise PCI Express transaction layer packets (TLP5).

7. The bus protocol compatible requester of claim 6, wherein the extended atomic operation generation system encodes an opcode for the extended atomic operation in a Last Byte Enable field in a PCI Express TLP if a TH bit in the PCI Express TLP is clear.

8. The bus protocol compatible requester of claim 6, wherein the extended atomic operation generation system encodes an opcode for the extended atomic operation in an ST field of a PCI Express TLP if a TH bit in the in the PCI Express TLP is set.

9. The bus protocol compatible requester of claim 8, wherein the atomic operation generation system further encodes the opcode in bits 7:4 of a steering tag field of a TLP packet header and moves an existing ST[7:4] field to reserved bits of a transaction processing hints (TPH) TLP Prefix.

10. A bus protocol compatible completer, comprising:
a bus protocol port for receiving bus protocol compatible requests from a bus protocol link; and
an extended atomic operation execution system, coupled to the bus protocol port, for decoding an extended atomic operation according to at least one bit in a field of a standard bus protocol request other than an opcode field, and executing the extended atomic operation according to the at least one bit.

11. The bus protocol compatible completer of claim 10, wherein the extended atomic operation execution system is further adapted to selectively provide a completion packet to the bus protocol port for transmission to a requester coupled to the bus protocol link.

12. The bus protocol compatible completer of claim 10, wherein the bus protocol is peripheral component interconnect (PCI) Express.

13. The bus protocol compatible completer of claim 12, wherein the opcode field comprises a PCI Express Type field.

14. The bus protocol compatible completer of claim 12, wherein the extended atomic operation execution system comprises a PCI Express root complex.

15. The bus protocol compatible completer of claim 12, wherein the extended atomic operation execution system comprises a PCI Express endpoint.

16. The bus protocol compatible completer of claim 12, wherein the standard bus protocol request comprises a PCI Express transaction layer packet (TLP).

17. The bus protocol compatible completer of claim 16, wherein the extended atomic operation execution system decodes an opcode for the extended atomic operation in a Last Byte Enable field if a TH bit is clear.

18. The bus protocol compatible completer of claim 16, wherein the extended atomic operation execution system decodes an opcode for the extended atomic operation from an ST field of a TLP packet header if a TH bit is set.

19. The bus protocol compatible completer of claim 18, wherein the atomic operation execution system further decodes the opcode from bits 7:4 of a steering tag (ST) field of the TLP packet header, and bits 7:4 of a steering tag from reserved bits of a transaction processing hints (TPH) TLP Prefix.

20. A method for encoding an extended atomic operation, comprising:
receiving the extended atomic operation;
determining a state of a TH bit in a transaction layer packet (TLP);
if the TH bit is clear:
encoding an opcode for the extended atomic operation in a last double word byte enable (BE) field of the transaction layer packet;
if the TH bit is set:
determining whether a TLP transaction processing hints (TPH) prefix is present;
if the TLP TPH prefix is not present, encoding an opcode for the extended atomic operation in a steering tag field; and
if the TLP TPH prefix is present, encoding the opcode in a reserved field of the TLP TPH prefix.
